(19) United States
(12) Patent Application Publication
(10) Pub. No.: US 2022/0034713 A1
(43) Pub. Date: Feb. 3, 2022

(54) Method and device for real-time measuring sunlight on buildings

(71) Applicant: Shenzhen XKool Technology CO., Ltd., Shenzhen (CN)

(72) Inventors: Wanyu He, Shenzhen (CN); Qiyun Wei, Shenzhen (CN)

(21) Appl. No.: 17/450,989

(22) Filed: Oct. 14, 2021

(51) Int. Cl. G01J 1/42; G06T 7/60; G06N 5/02

(52) U.S. Cl. CPC G01J 1/42; G06T 7/60; G01J 2001/4266; G06T 2207/10032; G06T 2207/20081; G06N 5/022

(57) ABSTRACT

A method and device for real-time measuring sunlight on buildings,comprises: receiving training satellite images of training buildings, analyzing training satellite image features, extracting training building outline information, training building height information and training information of profile sunlight map sequence of corresponding continuous height; according to the preset training latitude and longitude range, obtaining the corresponding training building outline information, training building height information and training information of profile sunlight map sequence of corresponding continuous height; and training to obtain a sunlight testing model; receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the buildings within cadastral land parcel according to the sunlight testing model.

### TECHNICAL FIELD

The present disclosure relates to the technical field of building sunlight testing, and in particular to a method and device for real-time measuring sunlight on buildings.

### BACKGROUND

Sunlight on buildings, a study of the relationship between sunlight and buildings and the application of sunlight in buildings based on the principle of direct sunlight and the standard of sunlight on building. The purpose of studying sunlight on buildings is to make full use of sunlight to meet indoor light environment and hygiene requirements, while preventing overheating in the room. Sunlight can meet the needs of building lighting, in kindergartens, nursing homes, hospital wards and homes, with the functions of sterilization with sufficient direct sunlight and promoting human health, etc. It can also improve indoor temperature in winter, and in some places, solar energy is also available for energy. The “Code for Planning and Design on Urban Residential Areas” also stipulates the reference day of sunlight assessment, period of effective sunlight, sunlight duration time etc., and it becomes mandatory provisions to meet the sunlight requirement, and the assessment of obtaining the sunlight on buildings and sites according to the standards and codes can measure whether the building sunlight standard and code is met.

The assessment workload of manual building sunlight measurement is large, and the accuracy of the measurement is not high, while the computer processing of building sunlight measurement can solve the above problems. Traditional sunlight testing software as an extension to Auto CAD (Auto CAD is a drafting program for drawing two-dimensional drawings and basic three-dimensional designs), the main steps include the following: (1) specifying the sunlight conditions; (2) specifying the outline as a building one by one and the height of the building; (3) generating the sunlight testing results, and return to (1) again if you need to modify the parameters or attributes. Using the traditional sunlight testing method requires a local installation of a program or plug-in based on Auto CAD to find the menu for sunlight testing in Auto CAD. This traditional method of building sunlight testing can have the following problems: (1) subject to the limited local computing resources, it cannot test too many buildings at once, since the computer may be unresponsive. (2) the traditional sunlight testing program for the designer's support is very unfriendly, once a certain change is made, it needs to re-import the parameters and re-select the area testing, and the editor real-time feedback cannot be achieved. (3) the traditional sunlight testing program for three-dimensional body expression ability is limited, for the split-level building and the hanging building, irregular building support is poor, and it cannot be applied to a variety of scenarios. (4) the traditional sunlight testing procedures to set the sunlight conditions are not flexible, it cannot set different sunlight conditions at once while testing and cannot synthetically export sunlight report.

Therefore, to those skilled in the art, how to provide a rational, efficient and accurate scheme of real-time measuring sunlight on buildings is an urgent technical problem to be solved.

### SUMMARY

The present disclosure provides a method and device for real-time measuring sunlight on buildings, in a bid to solve the problem of lack of rational, efficient and accurate plan of real-time measuring sunlight on buildings in the prior art.

The present disclosure provides a method for real-time measuring sunlight on buildings, comprising:

receiving training satellite images of training buildings, analyzing the training satellite image features, extracting the training building outline information, training building height information and training information of profile sunlight map sequence of corresponding continuous height;

obtaining the corresponding training building outline information, the training building height information and the corresponding training profile sunlight map sequence information according to the preset training latitude and longitude ranges, and training to obtain a sunlight testing model;

receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the building within cadastral land parcels according to the sunlight testing model.

Preferably, wherein obtaining the corresponding training building outline information, the training building height information and the corresponding training profile sunlight map sequence information according to the preset training latitude and longitude ranges, and training to obtain a sunlight testing model, namely:

acquiring the training time corresponding to each of the training satellite images;

obtaining the corresponding training building outline information, the training building height information and the corresponding training profile sunlight map sequence information according to the preset training latitude and longitude ranges; and training to obtain a sunlight testing model; the real-time sunlight testing model is obtained by training in combination with the described training time.

Preferably, wherein the method further comprises:

Receiving information on building outline modifications to the target building, modifying it in conjunction with adjacent information on the target building outline to obtain modified building outline information;

Based on the modified building outline information, the updated sunlight map sequence information for the building within cadastral land parcel is obtained in combination with the sunlight testing model.

Preferably, wherein the method further comprises:

obtaining information on the target building outline of the cadastral land parcel to be measured and sending it to the building measurement and assessment on cloud;

receiving a three-dimensional building interface fed back from the building measurement and assessment on cloud;

obtaining information on building outline modifications to the target building and sending it to the building measurement and assessment on cloud;

receiving the modified building outline information obtained from the building measurement and assessment on cloud feedback in combination with the 3D modification of the target building outline information in the vicinity.

Preferably, wherein the method further comprises:

receiving information on the building outline and height of the sunlight plane in the building within cadastral land parcel;

according to the sunlight map sequence of the building within cadastral land parcel, the building outline information and the height information, combined with the building outline information and the height information of the sunlight plane, the sequence of sunlight map is assessed corresponding to the sunlight plane.

On the other hand, The present disclosure also provides a device for real-time measuring sunlight on buildings, characterized in that, it comprises: a sunlight training data acquisition module, a sunlight training module of testing model and a real-time building sunlight measurement module; wherein

the sunlight training data acquisition module described above, connected to the sunlight training module of testing model, receiving training satellite images of training buildings, analyzing the training satellite image features, extracting the training building outline information, training building height information and training information of profile sunlight map sequence of corresponding continuous height;

The sunlight training module of testing model, connected to the sunlight training data acquisition module and the real-time building sunlight measurement module, according to the preset training latitude and longitude range, the corresponding training building outline information, the training building height information and the corresponding training profile sunlight map sequence information are obtained and trained to obtain the sunlight testing model;

The real-time building sunlight measurement module, connected to the training module of sunlight detection model, receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the buildings within cadastral land parcel according to the sunlight testing model.

Preferably, wherein the sunlight training module of testing model, comprising: a training timestamp acquisition unit and a training unit of real-time sunlight testing model; wherein

the training timestamp acquisition unit, connected to the sunlight training data acquisition module and training unit of real-time sunlight testing model to obtain the training timestamp corresponding to each the training satellite images;

the real-time sunlight training unit of testing model, connected to the training timestamp acquisition unit, the sunlight training data acquisition module and the real-time building sunlight measurement module, according to the preset training latitude and longitude range, the corresponding training building outline information, the training building height information and the corresponding training profile sunlight map sequence information are obtained; the real-time sunlight testing model is obtained by training in combination with the training time.

Preferably, wherein the device further comprises: sunlight testing update module, connected to the real-time building sunlight measuring module, receiving information on building outline modifications to the target building, modifying adjacent information on the target building outline to obtain modified building outline information;

Based on the modified building outline information, the updated sunlight map sequence information for the building within cadastral land parcel is obtained in combination with the sunlight testing model.

Preferably, wherein the device further comprising: building sunlight testing module on cloud, connected to the sunlight testing update module, sunlight training data acquisition module and real-time building sunlight measuring module to obtain information on the target building outline of the cadastral land parcel to be measured and send it to the building measurement and assessment on cloud;

Receiving a three-dimensional building interface fed back from the building measurement and assessment on cloud;

Obtaining information on building outline modifications to the target building and sending it to the building measurement and assessment on cloud;

Receive the modified building outline information obtained from the 3D modified neighboring target building outline 3D architectural interface of the building measurement on cloud feedback.

Preferably, wherein the device further comprises: specific plane sunlight testing module, connected to sunlight training data acquisition module and real-time building sunlight measuring module to receive the building outline information and height information of the sunlit plane in the building within cadastral land parcel;

According to the sunlight map sequence of the building within cadastral land parcel, the building outline information and the height information, combined with the building outline information and the height information of the sunlight plane, the sequence of sunlight map is assessed corresponding to the sunlight plane.

The present disclosure's method and device for real-time measuring sunlight on buildings collects a large amount of satellite image information of urban buildings, learns satellite image features through image information, and trains a sunlight testing model at the latitude and longitude in advance where each city is located by extracting building outline and height difference information from the images. According to the location of the user-selected cadastral land parcel, the applied sunlight testing model is decided, and the sunlight testing results are returned, which can provide real-time feedback on the building sunlight situation, making the designer's sunlight testing no longer a particularly tedious process that requires repeated interaction and can be constantly modified, greatly reducing the designer's burden on the basis of ensuring the accuracy of sunlight testing. It is possible to construct various shapes of buildings on the 3D interface, and the sunlight testing is based entirely on the real dimension of 3D, achieving a comprehensive building sunlight testing without leaving any corner behind.

### BRIEF DESCRIPTION OF THE DRAWINGS

In order to describe the technical solutions of the embodiments of the present disclosure, below is simple introduction to the figures used in the embodiment description of the present disclosure. Apparently, the figures described below are only some embodiments of the present disclosure, for those of ordinary skill in the art, other figures can also be obtained based on these figures without contribution of creative work.

FIG. 1 is the flow schematic chart of the method for real-time measuring sunlight on buildings in the embodiment of the present disclosure;

FIG. 2 is the flow schematic chart of the second method for real-time measuring sunlight on buildings in the embodiment of the present disclosure;

FIG. 3 is the flow schematic chart of the third method for real-time measuring sunlight on buildings in the embodiment of the present disclosure;

FIG. 4 is the flow schematic chart of the fourth method for real-time measuring sunlight on buildings in the embodiment of the present disclosure;

FIG. 5 is the flow schematic chart of the fifth method for real-time measuring sunlight on buildings in the embodiment of the present disclosure;

FIG. 6 is the flow schematic chart of an embodiment of the method for real-time measuring sunlight on buildings in the embodiment of the present disclosure;

FIG. 7 is the structure schematic chart of the device for real-time measuring sunlight on buildings in the embodiment of the present disclosure;

FIG. 8 is the structure schematic chart of the second device for real-time measuring sunlight on buildings in the embodiment of the present disclosure;

FIG. 9 is the schematic structural chart of the third device for real-time measuring sunlight on buildings in the embodiment of the present disclosure;

FIG. 10 is the structure schematic chart of the fourth device for real-time measuring sunlight on buildings in the embodiment of the present disclosure;

FIG. 11 is the structure schematic chart of the fifth device for real-time measuring sunlight on buildings in the embodiment of the present disclosure.

### DESCRIPTION OF EMBODIMENTS

Below is clear and complete description of the technical solutions in the embodiments of the present disclosure in conjunction with the figures of such embodiments, apparently, the embodiments described are some embodiments of the present disclosure only rather than all embodiments. Any other embodiment obtained by those of ordinary skill in the art based on the embodiments of the present disclosure without contribution of creative work is also within the protective scope of the present disclosure.

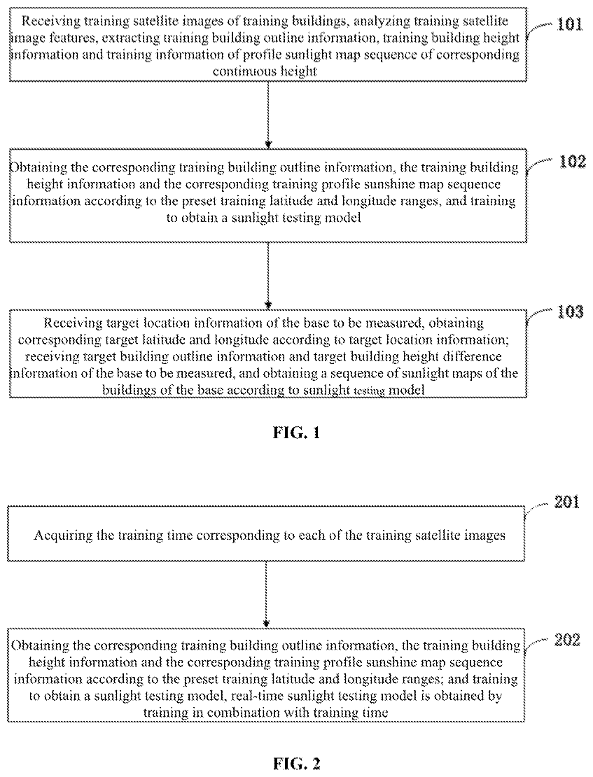

For the present disclosure for the method for real-time measuring sunlight on buildings, no matter how big the site is, it can be easily handled by cloud computing. Users can input building outline information, height information, measurement timestamp and peripheral building information and get the latest building sunlight measuring results immediately, what you see is what you get. Specifically, as shown in FIG. 1, it is the flow schematic chart of the method for real-time measuring sunlight on buildings in the embodiment of the present disclosure. The method comprising the following steps:

Step 101, receiving training satellite images of training buildings, analyzing training satellite image features, extracting training building outline information, training building height information and training information of profile sunlight map sequence of corresponding continuous height.

Preferably, the building satellite image of this method can also be other pictures or other information data that can respond to the building outline information, location information, height information and sunlight on buildings. The AI analysis model is constructed by analyzing the building parameters and sunlight conditions in each latitude and longitude range of the existing phase, and the sunlight conditions of each building in that latitude and longitude range can be predicted accurately and quickly.

Step 102, obtaining the corresponding training building outline information, the training building height information and the corresponding training profile sunlight map sequence information according to the preset training latitude and longitude range, and training to obtain a sunlight testing model.

Step 103, receiving target location information of the cadastral land parcel to be measured, obtaining corresponding target latitude and longitude according to target location information; receiving target building outline information and target building height difference information of the cadastral land parcel to be measured, and obtaining a sequence of sunlight maps of the buildings within cadastral land parcel according to sunlight testing model.

In some optional embodiments, as shown in FIG. 2, it is the flow schematic chart of the second method for real-time measuring sunlight on buildings in this embodiment, different from FIG. 1: According to the preset training latitude and longitude range, corresponding training building outline information, training building height information and corresponding training profile sunlight map sequence information are obtained; the sunlight testing model is obtained by training, namely:

Step 201, acquiring training time corresponding to each of the training satellite images.

Step 202, obtaining corresponding training building outline information, the training building height information and the corresponding training profile sunlight map sequence information according to the preset training latitude and longitude ranges; and training to obtain a sunlight testing model; the real-time sunlight testing model is obtained by training in combination with training time.

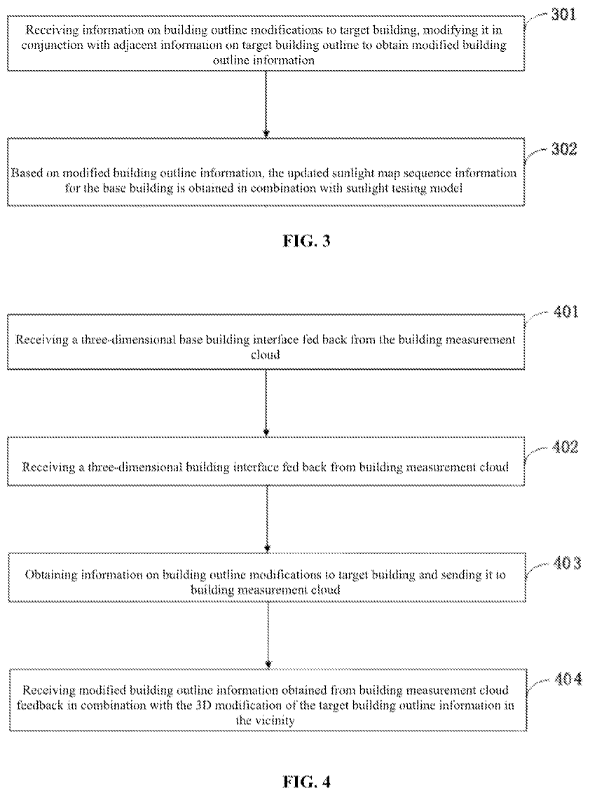

In some optional embodiments, as shown in FIG. 3, it is the flow schematic chart of the third method for real-time measuring sunlight on buildings in this embodiment, different from FIG. 1, further comprising:

Step 301, receiving information on building outline modifications to target building, modifying it in conjunction with adjacent information on target building outline to obtain modified building outline information.

Step 302, based on modified building outline information, the updated sunlight map sequence information for the building within cadastral land parcel is obtained in combination with sunlight testing model.

In some optional embodiments, as shown in FIG. 4, it is the flow schematic chart of the fourth method for real-time measuring sunlight on buildings in this embodiment, different from FIG. 3, further comprising:

Step 401, obtaining information on target building outline of the cadastral land parcel to be measured and sending it to the building measurement and assessment on cloud.

The building measurement and assessment on cloud can build a 3D architectural interface based on the target building outline information and peripheral information.

Step 402, receiving a three-dimensional architectural interface fed back from building measurement and assessment on cloud.

Step 403, obtaining information on building outline modifications to target building and sending it to building measurement and assessment on cloud.

The building measurement and assessment on cloud can build a 3D architectural interface based on the target building outline information, peripheral information and modifying information modification.

Step 404, receiving modified building outline information obtained from the building measurement and assessment on cloud feedback in combination with the 3D modification of target building outline information in the vicinity.

Benefiting from the platform's building editing function, users can construct buildings of various shapes and sizes on the 3D interface, and the sunlight testing is completely based on the real dimension of 3D, without missing any corner. This method innovatively introduces the sunlight grouping function, each group of buildings can specify different indexes and assessment conditions, which greatly facilitates the testing of multiple business types in the cadastral land parcel, such as kindergarten, residential buildings, office and apartment mixed business solutions. Based on the preset load of AI models and the outstanding computing capability of the cloud computing, the building sunlight testing speed of this method is three to five times faster than the traditional program testing with the same machine.

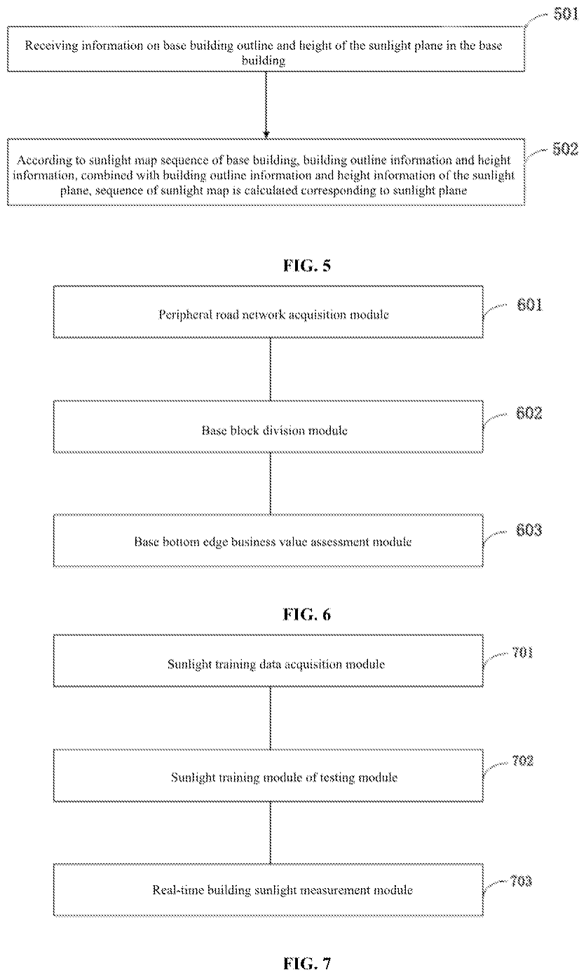

In some optional embodiments, as shown in FIG. 5, it is the flow schematic chart of the fifth method for real-time measuring sunlight on buildings in this embodiment, different from FIG. 1, further comprising:

Step 501, receiving information on building within cadastral land parcel outline and height of the sunlight plane in the building within cadastral land parcel.

Step 502, according to sunlight map sequence of the building within cadastral land parcel, the building outline information and the height information, combined with building outline information and the height information of the sunlight plane, sequence of sunlight map is assessed corresponding to the sunlight plane.

By analyzing the relationship between a specific plane (e.g. a window) and the overall plane of the building, and then combining the sunlight information of the whole building at each timestamp, obtain the sunlight situation of the specific plane at each timestamp by corresponding transformation calculation. More preferably, it also optimizes the sunlight situation of a specific plane at each timestamp by combining the information of the peripheral buildings, so that the sunlight situation of a specific plane can be obtained more accurately and quickly at any time.

In some optional embodiments, as shown in FIG. 6, it is the flow schematic chart of an embodiment of the method for real-time measuring sunlight on buildings in this embodiment, and the method comprise following steps:

Step 601, constructing a sunlight testing AI model based on the big data of urban building information and sunlight testing.

Step 602, the user selects the building information of the cadastral land parcel.

Step 603, based on the building information of the cadastral land parcel selected by user, combined with the sunlight testing AI model, getting the preset load of peripheral sunlight information around building.

Step 604, the user selects the specific program parameters of the building.

Step 605, the AI model for sunlight testing is preloaded with preliminary assessment of the building sunlight conditions based on the specific scheme parameters of the building selected by the user and the peripheral building sunlight information.

Step 606, based on the preliminary assessment results, the user modifies the building location and parameters and imports the preliminary assessment again.

Step 607, assessing the results on cloud again according to the user's modified parameters for building sunlight testing optimization.

Step 608, feeding back sunlight testing reports according to building sunlight testing optimization results on cloud.

Artificial Intelligence, abbreviated as AI, enables computers to simulate certain human thought processes and intelligent behaviors (such as learning, reasoning, thinking and planning), mainly including the principles of computers to achieve intelligence, manufacturing computers similar to the intelligence of the human brain, so that computers can achieve higher-level applications. By constructing AI testing model that correspond to building parameters and building sunlight conditions, as opposed to specifying sunlight conditions in the prior art, The way of generating sunlight testing results by specifying the outline as a building one by one and specifying the height of the building has undoubtedly greatly improved the efficiency of building sunlight testing.

The method is an easy-to-use cloud computing tool integrating multiple advanced technologies such as artificial intelligence, big data and smart display for sunlight testing tool, which can help designers easily complete sunlight testing under various conditions, and support real-time modification feedback, what you see is what you get. A sunlight testing model can be trained in advance at the latitude and longitude where each city is located. The input to the model is a series of building outlines and heights, and the output is a sequence of sunlight images for a number of continuous height profiles within that range.

Loading in advance the peripheral sunlight conditions into the scheme and returning the peripheral sunlight results through the sunlight model, the user can select different schemes within the cadastral land parcel, and each building can be assigned a different sunlight parameter. The test on cloud returns sunlight results, which include but are not limited to multi-height planar sunlight images, and sunlight calculations for each building derived from the sunlight images of different sunlight planes, which can be accurate to the exact time each window in each home can be sunlit on a given day. After getting the result, user can edit the parameters of the buildings as they like, and the sunlight testing result updates in real time, editing building parameters and returning new sunlight testing result is not a repeated interaction process anymore, user can obtain the latest result upon modification.

In some optional embodiments, as shown in FIG. 7, it is the structure schematic chart of the device for real-time measuring sunlight on buildings in this embodiment, the device can be used to implement the method for real-time measuring sunlight on buildings described above. Specifically, the device comprises: sunlight training data acquisition module 701, sunlight training module 702 of testing model and real-time building sunlight measurement module 703.

Where, the sunlight training data acquisition module 701, connected to sunlight training module 702 of testing model, receiving training satellite images of training buildings, analyzing training satellite image features, extracting training building outline information, training building height information and training information of profile sunlight map sequence of corresponding continuous height.

Sunlight training module 702 of testing model, connected to sunlight training data acquisition module 701 and the real-time building sunlight measurement module 703, according to the preset training latitude and longitude range, the corresponding training building outline information, the training building height information and the corresponding training profile sunlight map sequence information are obtained and trained to obtain the sunlight testing model.

Real-time building sunlight measurement module 703, connected to training module 702 of sunlight detection model, receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the buildings within cadastral land parcel according to sunlight testing model.

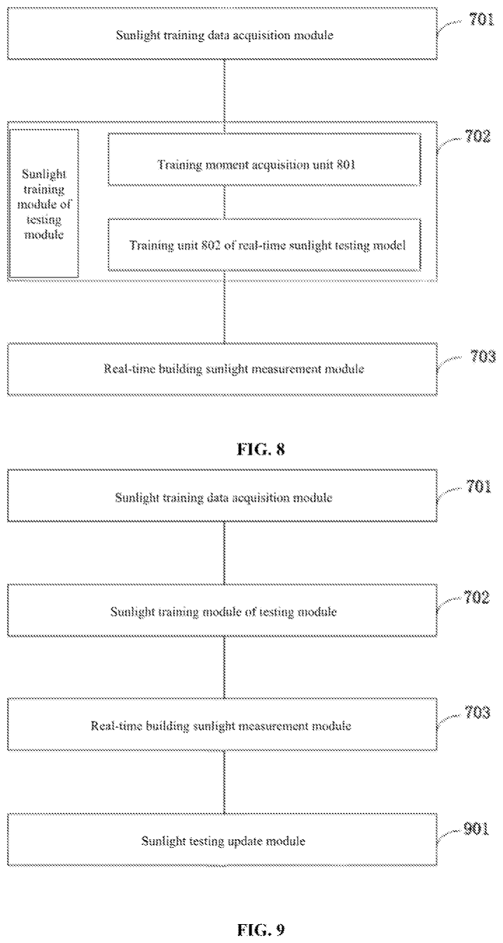

In some optional embodiments, as shown in FIG. 8, it is the structure schematic chart of the second device for real-time measuring sunlight on buildings in this embodiment, different from FIG. 7, sunlight training module of testing model 702, comprising: training timestamp acquisition unit 801 and a training unit 802 of real-time sunlight testing model.

Where, training timestamp acquisition unit 801, connected to sunlight training data acquisition module 701 and training unit 802 of real-time sunlight testing model to obtain the training timestamp corresponding to each training satellite image.

Real-time sunlight training unit 802 of testing model, connected to training timestamp acquisition unit 801, and the real-time building sunlight measurement module 703, according to the preset training latitude and longitude range, the corresponding training building outline information, the training building height information and the corresponding training profile sunlight map sequence information are obtained; the real-time sunlight testing model is obtained by training in combination with the training time.

In some optional embodiments, as shown in FIG. 7, it is the structure schematic diagram of the third device for real-time measuring sunlight on buildings in this embodiment, different from FIG. 9, further comprising: sunlight testing update module 901, connected to real-time building sunlight measurement module 703, receiving information on building outline modifications to the target building and modifying adjacent target building outline information to obtain modified building outline information; based on the modified building outline information, the updated sunlight map sequence information of this building within cadastral land parcel is obtained in combination with the sunlight testing model.

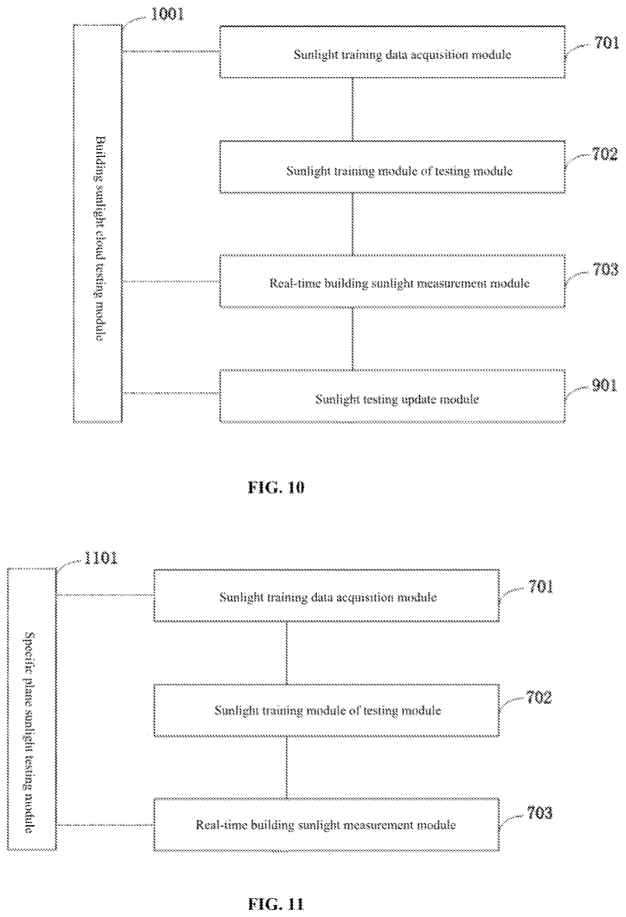

In some optional embodiments, as shown in FIG. 10, it is the structure schematic diagram of the fourth device for real-time measuring sunlight on buildings in this embodiment, different from FIG. 9, further comprising: building sunlight testing module on cloud 1001, connected to sunlight testing update module 901, sunlight training data acquisition module 701 and real-time building sunlight measuring module 703 to obtain information on target building outline of the cadastral land parcel to be measured and send it to the building measurement and assessment on cloud;

Receiving a three-dimensional architectural interface fed back from building measurement and assessment on cloud;

Obtaining information on building outline modifications to target building and sending it to building measurement and assessment on cloud;

Receiving modified building outline information obtained from the 3D modified neighboring target building outline 3D architectural interface of the building measurement and assessment on cloud feedback.

In some optional embodiments, as shown in FIG. 11, it is the structure schematic diagram of the fifth device for real-time measuring sunlight on buildings in this embodiment, different from FIG. 7, further comprising: specific plane sunlight testing module 1101, connected to sunlight training data acquisition module 701 and real-time building sunlight measuring module 703 to receive the building outline information and height information of the sunlit plane in the building within cadastral land parcel; according to sunlight map sequence of building within cadastral land parcel, building outline information and height information, combined with building outline information and height information of the sunlight plane, sequence of sunlight map is assessed corresponding to sunlight plane.

This embodiment can further comprise a computer device comprising memory, processor, and computer program stored in the memory and operable on the processor, the processor executes the computer program to implement the steps of real-time measuring method for sunlight on buildings as described above.

A readable storage medium storing computer program, which is characterized in that, the steps of real-time measuring sunlight on buildings as described above are implemented when the computer program is executed by the processor.

It can be understood by those of ordinary skill in the art that the whole or part of the process of the method in the above embodiment, it can be implemented by computer program instructing relevant hardware, the computer program can be stored in a non-volatile storage medium readable by computer, the execution of the computer program can comprise the processes in the embodiments of the methods described above. Where, any reference to memory, storage, database or other medium in the embodiments provided in this application may include both non-volatile memory and/or volatile memory. Non-volatile memory may include read-only memory (ROM), programmable ROM (PROM), electrically programmable ROM (EPROM), electrically erasable and programmable ROM (EEPROM) or flash memory. Volatile memory may include random access memory (RAM) or external cache memory. As illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Those skilled in the art can clearly understand that, for the convenience of concise description, only examples of the functional units and modules described above are given, in actual application, such functions described above can be assigned to different functional units and modules for completion based on the need, i.e., internal construction of the device can be divided into different functional units or modules to complete all or partial functions described above.

Embodiments described above are merely provided for description of the technical solutions of the present disclosure rather than limitation. Although the present disclosure has been described in detail in reference to the above embodiments, those of ordinary skill in the art shall understand that they can still modify the technical solutions described in the above embodiments, or conduct equivalent replacement to some technical features therein; but such modifications or replacements will not make the nature of the relevant technical solutions depart from the spirit and scope of the technical solution in the embodiments of the present disclosure, and shall be included in the protection scope of the present disclosure.

What is claimed is:

1. A method for real-time measuring sunlight on buildings, comprising:
receiving training satellite images of training buildings, analyzing the training satellite image features, extracting the training building outline information, training building height information and training information of profile sunlight map sequence of corresponding continuous height;
obtaining the corresponding training building outline information, the training building height information and the corresponding training profile sunlight map sequence information according to the preset training latitude and longitude range, and training to obtain a sunlight testing model;
receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the building within cadastral land parcels according to the sunlight testing model.

2. The method for real-time measuring sunlight on buildings according to claim 1, wherein according to the preset training latitude and longitude range, the corresponding training building outline information, the training building height information and the corresponding training profile sunlight map sequence information are obtained and trained to obtain the sunlight testing model comprises:
acquiring the training time corresponding to each of the training satellite images;
obtaining the corresponding training building outline information, the training building height information and the corresponding training profile sunlight map sequence information according to the preset training latitude and longitude ranges; and training to obtain a sunlight testing model; the real-time sunlight testing model is obtained by training in combination with the described training time.

3. The method for real-time measuring sunlight on buildings according to claim 1, further comprises:
receiving information on building outline modifications to the target building, modifying it in conjunction with adjacent information on the target building outline to obtain modified building outline information;
based on the modified building outline information, the updated sunlight map sequence information for the building within cadastral land parcel is obtained in combination with the sunlight testing model.

4. The method for real-time measuring sunlight on buildings according to claim 3, further comprises:
obtaining information on the target building outline of the cadastral land parcel to be measured and sending it to the building measurement and assessment on cloud;
receiving a three-dimensional architectural interface fed back from the building measurement and assessment on cloud;
obtaining information on building outline modifications to the target building and sending it to the building measurement and assessment on cloud;
receiving the modified building outline information obtained from the building measurement and assessment on cloud feedback in combination with the 3D modification of the target building outline information in the vicinity.

5. The method for real-time measuring sunlight on buildings according to claim 1, further comprises:
receiving information on the building outline and height of the sunlight plane in the building within cadastral land parcel;
according to the sunlight map sequence of the building within cadastral land parcel, the building outline information and the height information, combined with the building outline information and the height information of the sunlight plane, the sequence of sunlight map is assessed corresponding to the sunlight plane.

6. A device for real-time measuring sunlight on buildings, characterized in that, comprises: a sunlight training data acquisition module, a sunlight training module of testing model and a real-time building sunlight measurement module; wherein
the sunlight training data acquisition module described above, connected to the sunlight training module of testing model, receiving training satellite images of training buildings, analyzing the training satellite image features, extracting the training building outline information, training building height information and training information of profile sunlight map sequence of corresponding continuous height;
the sunlight training module of testing model, connected to the sunlight training data acquisition module and the real-time building sunlight measurement module, according to the preset training latitude and longitude range, the corresponding training building outline information, the training building height information and the corresponding training profile sunlight map sequence information are obtained and trained to obtain the sunlight testing model;
the real-time building sunlight measurement module, connected to the training module of sunlight testing model, receiving target location information of the cadastral land parcel to be measured, obtaining corresponding target latitude and longitude according to the target location information; receiving target building outline information and target building height difference information of the cadastral land parcel to be measured, and obtaining a sequence of sunlight maps of the buildings within cadastral land parcel according to the sunlight testing model.

7. The device for real-time measuring sunlight on buildings according to claim 6, comprises, the sunlight training module of testing model, comprising: a training timestamp acquisition unit and a training unit of real-time sunlight testing model; wherein
the training timestamp, acquisition unit, connected to the sunlight training data acquisition module and training unit of real-time sunlight testing model to obtain the training timestamp corresponding to each the training satellite images;
the real-time sunlight training unit of testing model, connected to the training timestamp acquisition unit, the sunlight training data acquisition module and the real-time building sunlight measurement module, according to the preset training latitude and longitude range, the corresponding training building outline information, the training building height information and the corresponding training profile sunlight map sequence information are obtained; the real-time sunlight testing model is obtained by training in combination with the training time.

8. The device for real-time measuring sunlight on buildings according to claim 6, further comprises: sunlight testing update module, connected to the real-time building sunlight measuring module, receiving information on building outline modifications to the target building, modifying adjacent information on the target building outline to obtain modified building outline information;
based on the modified building outline information, the updated sunlight map sequence information for the building within cadastral land parcel is obtained in combination with the sunlight testing model.

9. The device for real-time measuring sunlight on buildings according to claim 8, further comprises: building sunlight testing module on cloud, connected to the sunlight testing update module, sunlight training data acquisition module and real-time building sunlight measuring module to obtain information on the target building outline of the cadastral land parcel to be measured and send it to the building measurement and assessment on cloud;
receiving a three-dimensional architectural interface fed back from the building measurement and assessment on cloud;
obtaining information on building outline modifications to the target building and sending it to the building measurement and assessment on cloud;
receive the modified building outline information obtained from the 3D modified neighboring target building outline 3D building interface of the building measurement and assessment on cloud feedback.

10. The device for real-time measuring sunlight on buildings according to claim 6, further comprises: specific plane sunlight testing module, connecting with sunlight training data acquisition module and real-time building sunlight measuring module to receive the building outline information and height information of the sunlit plane in the building within cadastral land parcel;
according to the sunlight map sequence of the building within cadastral land parcel, the building outline information and the height information, combined with the building outline information and the height information of the sunlight plane, the sequence of sunlight map is assessed corresponding to the sunlight plane.
